(19) United States
(12) Patent Application Publication
(10) Pub. No.: US 2001/0020670 A1
(43) Pub. Date: Sep. 13, 2001

(54) Automatic power control circuit

(75) Inventor: Kikuo Hyoga, Saitama-ken (JP)

Correspondence Address: ARENT FOX KINTNER PLOTKIN & KAHN, PLLC, 1050 Connecticut Avenue, N.W., Suite 600, Washington, DC, 20036-5339, US

(73) Assignee: PIONEER CORPORATION

(21) Appl. No.: 09/791,837

(22) Filed: Feb. 26, 2001

(30) Foreign Application Priority Data
Mar. 1, 2000 (JP) 2000-55534

(51) Int. Cl. G01J 1/32

(52) U.S. Cl. 250/205

(57) ABSTRACT

The emission intensity of each light emitting element in a light source comprising a plurality of light emitting elements can be finely adjusted. Parallel connected variable resistors R1, R2 are connected in series to a monitor diode PD for detecting the emission intensity of light emitting elements LD1, LD2. The voltages Vr1, Vr2 generated at the movable contact of the variable resistors R1, R2 are supplied to the non-inversion input terminals of differential amplifiers OP1, OP2 respectively, while reference voltages Vref1, Vref2 are applied to the inversion input terminals of the differential amplifiers OP1, OP2. When adjusting the emission intensity of the light emitting element LD1, a switching element SW1 is set to a conducting state and a switching element SW2 is set to a non-conducting state, so as to finely adjust the resistance value of the variable resistor R1. When the emission intensity of the light emitting element LD2 is to be adjusted, the switching element SW1 is set to a non-conducting state and the switching element SW2 is set to a conducting state, and the resistance value of the variable resistor R2 is adjusted finely. By this type of fine adjustments, driving currents Id1, Id2 of the light emitting elements LD1, LD2 can be set to values proportional with the resistance values of the variable resistors R1, R2, enabling the emission intensities to be set at desired levels.

### BACKGROUND OF THE INVENTION

The present invention relates to an automatic power control circuit for controlling automatically the light emission intensity from a light emitting element in a device such as a semiconductor laser or a light emitting diode.

Conventionally, these types of automatic power control circuits (APC) have been used in the optical pickup provided in CD (Compact Disc) players and DVD (Digital Video Disc or Digital Versatile Disc) players.

As shown in FIG. 12, the optical pickup comprises a light source which is constructed such that a semiconductor laser LD and a photodiode PD which functions as a light detecting element (and is hereafter referred to as a monitor diode) are integrated together within a single package PKG, and the writing of information to, or reading of information from the CD or DVD is performed by irradiating light emitted from the semiconductor laser LD onto the CD or DVD surface.

An automatic power control circuit is constructed of a differential amplifier OP, a variable resistor R, and a constant voltage source E for generating a reference voltage Vref of a constant voltage. Furthermore, the variable resistor R is connected between the anode and the cathode of the monitor diode PD, the reference voltage Vref is applied to the non-inversion input terminal of the differential amplifier OP, and a voltage Vr generated at the variable resistor R is applied to the inversion input terminal of the differential amplifier OP. The anode of the semiconductor laser LD is connected to the output terminal of the differential amplifier OP.

The variable resistor R converts a photoelectric current Ipd, generated when the monitor diode PD detects a portion of the light emitted from the semiconductor laser LD, into the voltage Vr, and the differential amplifier OP compares the voltage Vr with the reference voltage Vref. Then, in order to constantly maintain the voltage differential (Vref−Vr) at a level not higher than a certain constant value, uses feedback control of the DC bias current (hereafter referred to as the driving current) Id of the semiconductor laser LD to maintain the emission intensity of the semiconductor laser LD at a constant level.

Furthermore, if the resistance value of the variable resistor R is varied, then the voltage Vr changes immediately, and so does the driving current Id. Then, because the emission intensity of the semiconductor laser LD varies in accordance with the variation in the driving current Id, the photoelectric current Ipd also varies accordingly, and so the voltage Vr returns to an original value within a predetermined time constant. Consequently, by fine adjustments of the resistance value of the variable resistor R, the emission intensity of the light emitted from the semiconductor laser LD can be adjusted to a level appropriate for the writing of information to, or reading of information from, a CD or DVD.

However, the recording density used on information recording media such as the aforementioned CD and DVD has increased, and as a result a large variety of information recording media with physically different optical characteristics have been developed and are available commercially.

As a result, there is a growing demand for CD players or DVD players with so-called “compatibility”, which are able to use information recording media of different optical characteristics, and do not require differentiation between the different types of media.

In order to meet this demand, a light source has been developed which is structured so that, as shown in FIG. 13, semiconductor lasers LD1, LD2 emitting lights of different wavelengths, and a monitor diode PD are integrated together within a single package PKG to produce an optical pickup in which the semiconductor lasers LD1 and LD2 may be switched in accordance with information recording media of different optical characteristics.

Then, in order to perform automatic adjustments of the emission intensity from the semiconductor lasers LD1, LD2, tests were conducted with the automatic power control circuit shown in FIG. 13. Namely, a construction was tested in which, as shown in FIG. 13, two differential amplifiers OP1, OP2 were provided for driving the semiconductor lasers LD1, LD2 respectively, the photoelectric current Ipd generated by the monitor diode PD was converted by the variable resistor R to the voltage Vr, and this voltage Vr, and the reference voltage Vref were applied to the non-inversion input terminal and the inversion input terminal respectively of the differential amplifiers OP1, OP2.

Then, when the emission intensity of the semiconductor laser LD1 was to be adjusted, the variable resistor R was adjusted with only the semiconductor laser LD1 emitting light, and similarly when the emission intensity of the semiconductor laser LD2 was to be adjusted, the variable resistor R was adjusted with only the semiconductor laser LD2 emitting light.

However, with the automatic power control circuit shown in FIG. 13, because the driving voltages Id1, Id2 supplied to the semiconductor lasers LD1, LD2 both undergo fine adjustment by using the variable resistor R, a problem occurs in which the respective emission intensities of the two semiconductor lasers LD1, LD2 could not be adjusted individually with a good degree of accuracy.

### SUMMARY OF THE INVENTION

The present invention has been made to overcome the problems of the prior art, and in particular an object of the present invention is to provide an automatic power control circuit in which the emission intensity of each light emitting element can be adjusted separately and accurately, even in those cases where the number of light detecting elements for monitorring purposes is fewer than the number of light emitting elements.

An automatic power control circuit of the present invention is provided for automatically controlling emission intensity of each of a plurality of light emitting elements of a light source. The circuit comprises the plurality of light emitting elements and a light detecting element for detecting a portion of a light emitted from each of said light emitting elements. The circuit further comprises a plurality of variable resistors connected in series in relation to said light detecting element, and a plurality of differential amplifiers for comparing each voltage generated at each of said variable resistors with a predetermined reference voltage and then adjusting a driving current of each of said light emitting elements so that a difference between each of said voltages and said reference voltage is no more than a certain constant. In particular, a resistance value of each of said variable resistors is finely adjusted to finely adjust said driving current of each of said light emitting elements, so as to maintain said emission intensity of each of said light emitting elements at a value corresponding to either said resistance value, or a position of a movable contact, of each finely adjusted variable resistor.

According to such a construction, a detection signal corresponding to the intensity of the light emitted from each of the light emitting elements is generated in the light detecting element, and moreover a voltage drop corresponding to the detection signal is generated at each of the variable resistors. If the resistance value of each of the variable resistors is finely adjusted, then the automatic power control circuit of the present invention can adjust the emission intensity of those light emitting elements which are emitting light, both separately and accurately, so as to maintain the emission intensity of each light emitting element in a finely adjusted state.

### BRIEF DESCR1PTION OF THE DRAWINGS

These and other objects and advantages of the present invention will become clear from the following description with reference to the accompanying drawings, wherein:

FIG. 1 is a circuit diagram showing the construction of an automatic power control circuit of a first embodiment;

FIG. 2 is a circuit diagram showing details of the construction of the switching element SWO in FIG. 1;

FIG. 3 is a circuit diagram showing the construction of an automatic power control circuit of a second embodiment;

FIG. 4 is a circuit diagram showing the construction of an automatic power control circuit of a third embodiment;

FIG. 5 is a circuit diagram showing the construction of an automatic power control circuit of a fourth embodiment;

FIG. 6 is a circuit diagram showing the construction of an automatic power control circuit of a fifth embodiment;

FIG. 7 is a circuit diagram showing the construction of an automatic power control circuit of a sixth embodiment;

FIG. 8 is a circuit diagram showing the construction of an automatic power control circuit of a seventh embodiment;

FIG. 9 is a circuit diagram showing the construction of an automatic power control circuit of an eighth embodiment;

FIG. 10 is a circuit diagram showing the construction of an automatic power control circuit of a ninth embodiment;

FIG. 11 is a circuit diagram showing the construction of an automatic power control circuit of a tenth embodiment;

FIG. 12 is a circuit diagram showing the construction of a conventional automatic power control circuit; and

FIG. 13 is a circuit diagram showing the construction of another conventional automatic power control circuit.

### DETAILED DESCR1PTION OF THE PREFERRED EMBODIMENTS

In the following, several embodiments of an automatic power control circuit of the present invention will be described, with reference to the drawings. One embodiment describes an automatic power control circuit which is provided within an optical pickup for optically writing information to or reading information from an information recording medium such as a CD or a DVD, and which causes a semiconductor laser to emit light.

[First Embodiment]

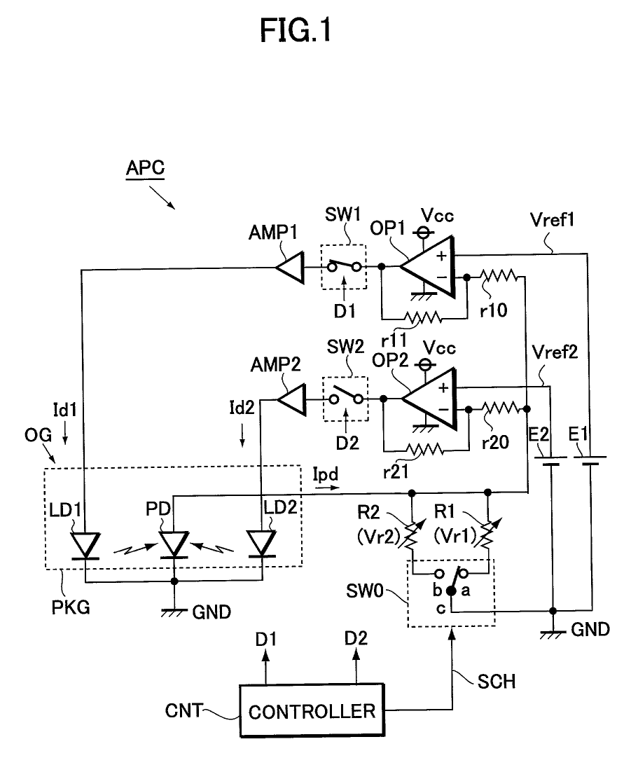

FIG. 1 is a circuit diagram showing the construction of an automatic power control circuit of a first embodiment. In the figure, a light source OG provided in an optical pickup (not shown in the drawing) is of a construction wherein two semiconductor lasers LD1, LD2, and a single monitor diode PD functioning as a light detector are integrated together inside a package PKG.

The monitor diode PD detects a portion of the light emitted from the semiconductor lasers LD1, LD2. In other words, if the semiconductor laser LD1 is emitting light and the semiconductor laser LD2 is not emitting light, then the monitor diode PD detects a portion of the light emitted from the semiconductor laser LD1, whereas if the light emission from the semiconductor laser LD1 is halted and light is emitted from the semiconductor laser LD2, then the monitor diode PD detects a portion of the light emitted from the semiconductor laser LD2.

Furthermore, the cathodes of both semiconductor lasers LD1, LD2 and the cathode of the monitor diode PD are connected to a grounded terminal GND. More specifically, the cathodes of both semiconductor lasers LD1, LD2 and the cathode of the monitor diode PD are connected in common inside the package PKG, and this commonly connected cathode is then connected to the ground terminal GND.

An automatic power control circuit APC of this embodiment comprises two differential amplifiers OP1, OP2, power amplifiers AMP1, AMP2 which function as buffer amplifiers, switching elements SW1, SW2 based on an analog switch, constant voltage sources E1, E2 for generating the constant reference voltages Vref1, Vref2, variable resistors R1, R2, a switching element SW0 and a controller CNT.

The differential amplifier OP1 is set at a predetermined gain G1 determined by resistors r10, r11, and the differential amplifier OP2 is set at a predetermined gain G2 determined by resistors r20, r21. The resistance value of the resistor r10 should preferably be considerably larger than the resistance value of the variable resistor R1, and the resistance value of the resistor r20 should preferably be considerably larger than the resistance value of the variable resistor R2. In other words, it is preferable that the settings satisfy the relationships r10>>R1, and r20>>R2.

Furthermore, the differential amplifiers OP1, OP2 are driven by a source voltage Vcc which is positive with respect to the ground terminal GND.

Furthermore, the output terminal of the differential amplifier OP1 is connected to the anode of the semiconductor laser LD1 via the switching element SW1 and the power amplifier AMP1, and the output terminal of the differential amplifier OP2 is connected to the anode of the semiconductor laser LD2 via the switching element SW2 and the power amplifier AMP2.

The non-inversion input terminals of the differential amplifiers OP1, OP2 are connected to the anode of the monitor diode PD via the resistors r10, r20 respectively, whereas the inversion input terminal of the differential amplifier OP1 is connected to the constant voltage source E1, and the inversion input terminal of the differential amplifier OP2 is connected to the constant voltage source E2.

The reference voltages Vref1, Vref2 of the constant voltages E1, E2 respectively are set at a lower voltage than the source voltage Vcc, satisfying the relationships 0<Vref1<Vcc, and 0<Vref2<Vcc.

The two variable resistors R1, R2 are connected in common at one end to the anode of the monitor diode PD, whereas the respective other ends are connected to the transfer contacts a, b respectively of the switching element SW0. The common contact c of the switching element SW0 is connected to the ground terminal GND. Consequently, when the switching element SW0 is switched to the transfer contact a, the variable resistor R1 is connected in parallel relative to the monitor diode PD, whereas when the switching element SW0 is switched to the transfer contact b, the variable resistor R2 is connected in parallel relative to the monitor diode PD.

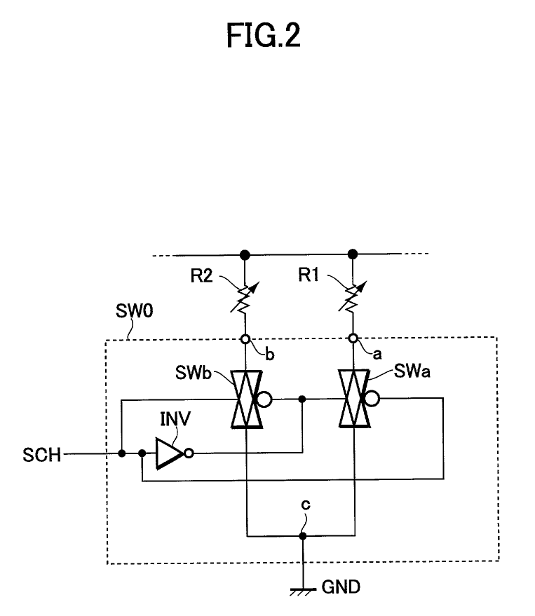

As shown in FIG. 2, the switching element SW0 comprises analog switches SWa, SWb and an inverter INV. The connection of the variable resistors R1, R2 relative to the monitor diode PD is switched across by using a switching signal SCH for effecting exclusive ON/OFF control of the analog switches SWa, SWb.

In other words, when a logic “L” switching signal SCH is supplied, the analog switch SWa shifts to a conducting state and the analog switch SWb shifts to a non-conducting state, and the variable resistor R1 is connected in parallel relative to the monitor diode PD. When a logic “H” switching signal SCH is supplied, the analog switch SWa shifts to a non-conducting state and the analog switch SWb to a conducting state, and the variable resistor R2 is connected in parallel relative to the monitor diode PD.

The controller CNT comprises a microprocessor (MPU) or the like, for controlling the switching of the aforementioned switching elements SW0, SW1, SW2 via control signals D1, D2, SCH. In this embodiment, switching is controlled such that when the switching signal SCH is used to connect the switching element SW0 to the transfer contact a, the control signals D1, D2 are used to set the switching element SW1 to a conducting state, and the switching element SW2 to a non-conducting state, whereas when the switching element SW0 is connected to the transfer contact b, the control signals D1, D2 are used to set the switching element SW1 to a nonconducting state, and the switching element SW2 to a conducting state.

In the following, the operation of an automatic power control circuit APC of the construction described above will be described.

To adjust the emission intensity of the semiconductor laser LD1, the controller CNT is instructed to connect the switching element SW0 to the transfer contact a so that only the variable resistor R1 is connected in parallel relative to the monitor diode PD. Moreover, the switching element SW1 is set to a conducting state and the switching element SW2 to a non-conducting state.

When the switching of the switching elements SW0, SW1, SW2 is controlled in this manner, a photoelectric current Ipd corresponding to the intensity of the light emitted by the semiconductor laser LD1 is generated in the monitor diode PD, and moreover, a voltage Vr1 in proportion to the photoelectric current Ipd is generated at the variable resistor R1, and this voltage Vr1 is applied to the inversion input terminal of the differential amplifier OP1. In other words, light emission from the semiconductor laser LD1 and light detection thereof by the monitor diode PD may be conducted in the following way. Namely, the differential amplifier OP1 compares the voltage Vr1 with the reference voltage Vref1 and then supplies the voltage differential G1×(Vref1−Vr1) to the power amplifier AMP1 via the switching element SW1, and the power amplifier AMP1 then supplies a driving current Id1 proportional to the voltage differential G1×(Vref1−Vr1) to the semiconductor laser LD1, thereby effecting the light emission from the semiconductor laser LD1 and light detection thereof by the monitor diode PD.

In this state, by finely adjusting the resistance value of the variable resistor R1, and varying the voltage Vr1 and the voltage differential G1×(Vref1−Vr1), the driving current Id1 can be finely adjusted, thereby finely adjusting the emission intensity of the semiconductor laser LD1 to a desired intensity. Thereby, the voltage Vr1 returns to an original value over a predetermined time constant, as described in the above.

To adjust the emission intensity of the semiconductor laser LD2, the controller CNT is instructed to connect the switching element SW0 to the transfer contact b so that only the variable resistor R2 is connected in parallel relative to the monitor diode PD. Moreover, the switching element SW1 is set to a non-conducting state and the switching element SW2 to a conducting state.

When the switching of the switching elements SW0, SW1, SW2 is controlled in this manner, a photoelectric current Ipd corresponding to the intensity of the light emitted by the semiconductor laser LD2 is generated in the monitor diode PD, and moreover, a voltage Vr2 in proportion to the photoelectric current Ipd is generated at the variable resistor R2, and this voltage Vr2 is applied to the inversion input terminal of the differential amplifier OP2. In other words, light emission from the semiconductor laser LD2 and light detection thereof by the monitor diode PD may be conducted in the following way. Namely, the differential amplifier OP2 compares the voltage Vr2 with the reference voltage Vref2 and then supplies the voltage differential G2×(Vref2−Vr2) to the power amplifier AMP2 via the switching element SW2, and the power amplifier AMP2 then supplies a driving current Id2 proportional to the voltage differential G2×(Vref2−Vr2) to the semiconductor laser LD2, thereby effecting the light emission from the semiconductor laser LD2 and light detection thereof by the monitor diode PD.

In this state, by finely adjusting the resistance value of the variable resistor R2, and varying the voltage Vr2 and the voltage differential G2×(Vref2−Vr2), the driving current Id2 can be finely adjusted, thereby finely adjusting the emission intensity of the semiconductor laser LD2 to a desired intensity. Thereby, the voltage Vr2 returns to an original value over a predetermined time constant, as described in the above.

By controlling the switching of the switching elements SW0, SW1, SW2 in this manner, and finely adjusting the respective resistance values of the variable resistors R1, R2, the driving currents (namely, the DC bias currents) Id1, Id2 of the semiconductor lasers LD1, LD2 produced by the automatic power control circuit APC can be adjusted to desired levels, and the emission intensities of the semiconductor lasers LD1, LD2 can be optimized for the optical writing of information to, or reading of information from, an information recording medium such as a CD or a DVD.

When using the semiconductor laser LD1 for the writing or reading of information, by setting the switching element SW1 to a conducting state and the switching element SW2 to a non-conducting state, and moreover connecting the switching element SW0 to the transfer contact a, the emission intensity of the semiconductor laser LD1 according to the automatic power control circuit APC of this embodiment can be maintained at a finely adjusted value.

Furthermore, when using the semiconductor laser LD2 for the writing or reading of information, by setting the switching element SW1 to a non-conducting state and the switching element SW2 to a conducting state, and moreover connecting the switching element SW0 to the transfer contact b, the emission intensity of the semiconductor laser LD2 according to the automatic power control circuit APC of this embodiment can be maintained at a finely adjusted value.

In this manner, according to the automatic power control circuit APC of the present embodiment, even with a light source OG which is provided with only one monitor diode PD for two semiconductor lasers LD1, LD2, the emission intensities of the two semiconductor lasers LD1, LD2 can be finely adjusted, separately and accurately, in accordance with the output from the monitor diode PD.

[Second Embodiment]

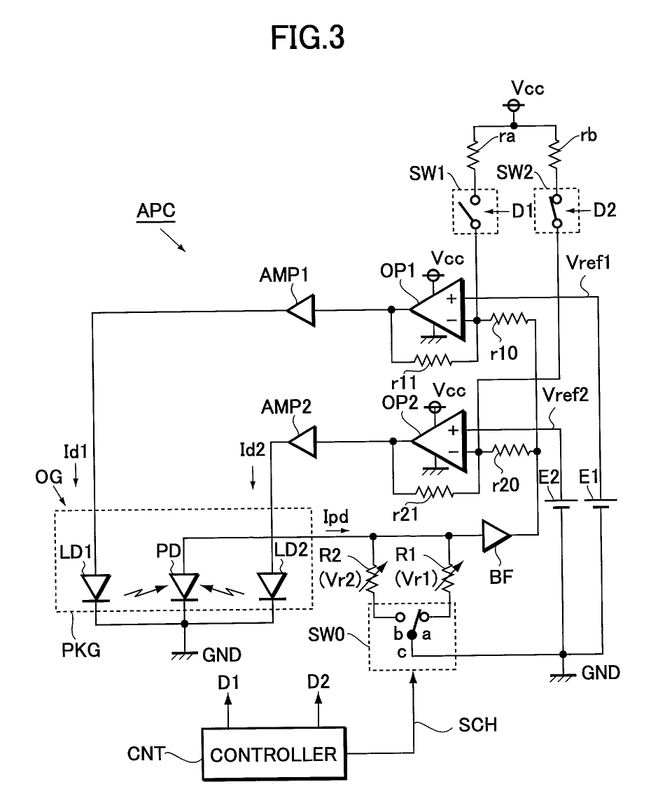

A second embodiment will be described below with reference to FIG. 3. In FIG. 3, those components which are the same as, or correspond to, those of FIG. 1 are represented by the same reference numerals.

The difference between the automatic power control circuit APC of this second embodiment shown in FIG. 3 and the automatic power control circuit APC shown in FIG. 1, is that in the automatic power control circuit APC shown in FIG. 1 the switching elements SW1, SW2 are provided between the differential amplifiers OP1, OP2 and the power amplifiers AMP1, AMP2 respectively, in the automatic power control circuit APC of this embodiment, the switching elements SW1, SW2 are provided between a source voltage Vcc and the inversion input terminals of the differential amplifiers OP1, OP2 respectively.

In other words, the switching element SW1 is connected between the inversion input terminal of the differential amplifier OP1 and the source voltage Vcc via a resistor ra, and the switching element SW2 is connected between the inversion input terminal of the differential amplifier OP2 and the source voltage Vcc via a resistor rb.

Furthermore, a buffer amplifier BF is provided between the monitor diode PD and the resistors r10, r20.

In the automatic power control circuit APC of this type of construction, to adjust the emission intensity of the semiconductor laser LD1, the controller CNT is instructed to connect the switching element SW0 to the transfer contact a so that only the variable resistor R1 is connected in parallel relative to the monitor diode PD. Moreover, the switching element SW1 is set to a non-conducting state and the switching element SW2 to a conducting state.

When the switching of the switching elements SW0, SW1, SW2 is controlled in this manner, the potential at the inversion input terminal of the differential amplifier OP2 is larger than the reference voltage Vref2, and so the differential amplifier OP2 switches to an OFF state, and the semiconductor laser LD2 loses the supply of the driving current Id2 and shifts to a non-emitting state.

In contrast, the potential at the inversion input terminal of the differential amplifier OP1 is lower than the reference voltage Vref1, so that the differential amplifier OP1 switches to an operational state, and the semiconductor laser LD1 is supplied with the driving current Id1 and emits light. Then, a photoelectric current Ipd corresponding to the intensity of the light emitted is generated in the monitor diode PD, and moreover, a voltage Vr1 in proportion to the photoelectric current Ipd is generated at the variable resistor R1, and this voltage Vr1 is applied to the inversion input terminal of the differential amplifier OP1 through the buffer amplifier BF. In other words, light emission from the semiconductor laser LD1 and light detection thereof by the monitor diode PD may be conducted in the following way. Namely, the differential amplifier OP1 compares the voltage Vr1 with the reference voltage Vref1 and then supplies the voltage differential G1×(Vref1−Vr1) to the power amplifier AMP1 via the switching element SW1, and the power amplifier AMP1 then supplies a driving current Id1 proportional to the voltage differential G1×(Vref1−Vr1) to the semiconductor laser LD1, thereby effecting the light emission from the semiconductor laser LD1 and light detection thereof by the monitor diode PD.

In this state, by finely adjusting the resistance value of the variable resistor R1, and varying the voltage Vr1 and the voltage differential G1×(Vref1−Vr1), the driving current Id1 can be finely adjusted, thereby finely adjusting the emission intensity of the semiconductor laser LD1 to a desired intensity. Thereby, the voltage Vr1 returns to an original value over a predetermined time constant, as described in the above.

To adjust the emission intensity of the semiconductor laser LD2, the controller CNT is instructed to connect the switching element SW0 to the transfer contact b so that only the variable resistor R2 is connected in parallel relative to the monitor diode PD. Moreover, the switching element SW1 is set to a conducting state and the switching element SW2 to a non-conducting state.

When the switching of the switching elements SW0, SW1, SW2 is controlled in this manner, the potential at the inversion input terminal of the differential amplifier OP1 is larger than the reference voltage Vref1, so that the differential amplifier OP1 switches to an OFF state, and the semiconductor laser LD1 loses the supply of the driving current Id1 and shifts to a non-emitting state.

In contrast, the potential at the inversion input terminal of the differential amplifier OP2 is lower than the reference voltage Vref2, so that the differential amplifier OP2 switches to an operational state, and the semiconductor laser LD2 is supplied with the driving current Id2 and emits light. Then, a photoelectric current Ipd corresponding to the intensity of the light emitted is generated in the monitor diode PD, and moreover, a voltage Vr2 in proportion to the photoelectric current Ipd is generated at the variable resistor R2, and this voltage Vr2 is applied to the inversion input terminal of the differential amplifier OP2 through the buffer amplifier BF. In other words, light emission from the semiconductor laser LD2 and light detection thereof by the monitor diode PD may be conducted in the following way. Namely, the differential amplifier OP2 compares the voltage Vr2 with the reference voltage Vref2 and then supplies the voltage differential G2×(Vref2−Vr2) to the power amplifier AMP2 via the switching element SW2, and the power amplifier AMP2 then supplies a driving current Id2 proportional to the voltage differential G2×(Vref2−Vr2) to the semiconductor laser LD2, thereby effecting the light emission from the semiconductor laser LD2 and light detection thereof by the monitor diode PD.

In this state, by finely adjusting the resistance value of the variable resistor R2, and varying the voltage Vr2 and the voltage differential G2×(Vref2−Vr2), the driving current Id2 can be finely adjusted, thereby finely adjusting the emission intensity of the semiconductor laser LD2 to a desired intensity. Thereby, the voltage Vr2 returns to an original value over a predetermined time constant, as described in the above.

In this way, by controlling the switching of the switching elements SW0, SW1, SW2 in this manner, and finely adjusting the respective resistance values of the variable resistors R1, R2, the driving currents (namely, the DC bias currents) Id1, Id2 of the semiconductor lasers LD1, LD2 produced by the automatic power control circuit APC can be adjusted to desired levels, and the emission intensities of the semiconductor lasers LD1, LD2 can be optimized for the optical writing of information to, or reading of information from, an information recording medium such as a CD or a DVD. Furthermore, even with a light source OG which is provided with only one monitor diode PD for two semiconductor lasers LD1, LD2, the emission intensities of the two semiconductor lasers LD1, LD2 can be finely adjusted, separately and accurately, in accordance with the output from the monitor diode PD.

[Third Embodiment]

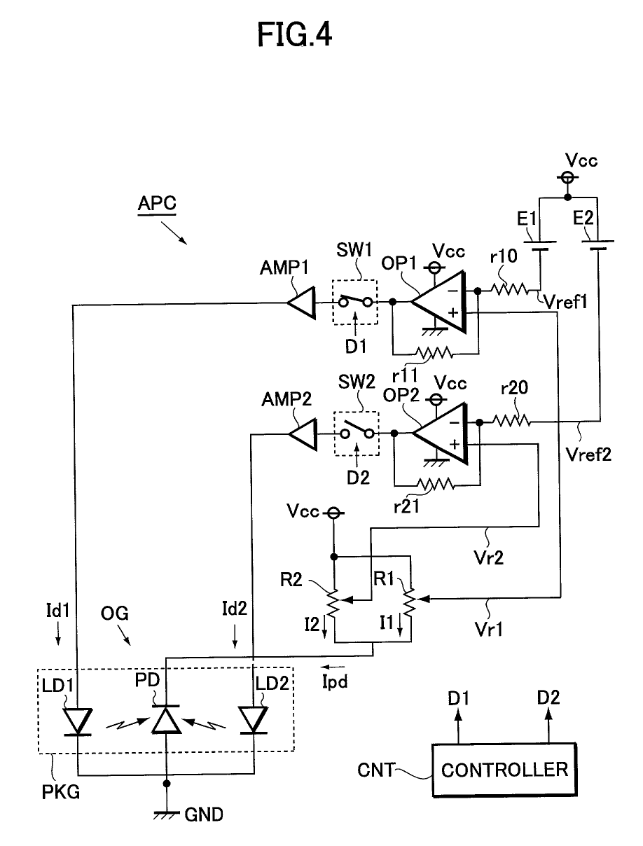

Next, a third embodiment will be described with reference to FIG. 4. In FIG. 4, components which are the same as, or correspond to, those of FIG. 1 are represented by the same reference numerals.

A circuit shown in FIG. 4 (third embodiment) differs from the circuit shown in FIG. 1 in that in an automatic power control circuit APC of this third embodiment, the monitor diode PD is connected with reverse bias relative to the source voltage Vcc and the ground terminal GND, so that the anode of the monitor diode PD is connected to the ground terminal GND and the cathode thereof is connected to the source voltage Vcc via the variable resistors R1, R2.

Furthermore, the variable resistors R1, R2 are connected in parallel, the movable contact of the variable resistor R1 is connected to the non-inversion input terminal of the differential amplifier OP1, and the movable contact of the variable resistor R2 is connected to the non-inversion input terminal of the differential amplifier OP2.

In addition, a reference voltage Vref1, which is lower than the source voltage Vcc by an amount equivalent to a constant voltage source E1, is applied to the inversion input terminal of the differential amplifier OP1 via the resistor r10, and a reference voltage Vref2, which is lower than the source voltage Vcc by an amount equivalent to a constant voltage source E2, is applied to the inversion input terminal of the differential amplifier OP2 via the resistor r20.

Next, description will be given to explain the operation of the automatic power control circuit APC formed according to the present embodiment.

To adjust the emission intensity of the semiconductor laser LD1, the controller CNT is instructed to switch the switching element SW1 to a conducting state and the switching element SW2 to a non-conducting state in accordance with the control signals D1, D2.

By controlling the switching elements SW1, SW2 in this manner, a photoelectric current Ipd corresponding to the intensity of the light emitted by the semiconductor laser LD1 is generated in the monitor diode PD, and moreover, photocurrents I1, I2 formed by current division in proportion to the resistance values of the two variable resistors R1, R2 flow through the variable resistors R1, R2 respectively. Furthermore, equal voltage drops (I1×R1)=I2×R2) occur at both ends of the variable resistors R1, R2.

Furthermore, at the movable contact of the variable resistor R1, a divided voltage Vr1 is generated which corresponds to the position of the movable contact, and similarly at the movable contact of the variable resistor R2, a divided voltage Vr2 is generated which corresponds to the position of this movable contact. Then, the divided voltage Vr1 is applied to the non-inversion input terminal of the differential amplifier OP1, and the divided voltage Vr2 is applied to the non-inversion input terminal of the differential amplifier OP2.

When the voltage Vr1 is applied to the differential amplifier OP1 in this manner, light emission from the semiconductor laser LD1 and light detection thereof by the monitor diode PD may be conducted in the following way. Namely, the differential amplifier OP1 compares the voltage Vr1 with the reference voltage Vref1 and then supplies the voltage differential G1×(Vref1−Vr1) to the power amplifier AMP1 via the switching element SW1, and the power amplifier AMP1 then supplies a driving current Id1 proportional to the voltage differential G1×(Vref1−Vr1) to the semiconductor laser LD1, thereby effecting the light emission from the semiconductor laser LD1 and light detection thereof by the monitor diode PD.

In contrast, although the differential amplifier OP2 compares the voltage Vr2 with the reference voltage Vref2 in a similar manner, and outputs the voltage differential G2×(Vref2−Vr2) to the switching element SW2, because the switching element SW2 is in a non-conducting state, the semiconductor laser LD2 is not supplied with the driving current Id2 and remains in a non-emitting state.

In this state, by finely adjusting the position of the movable contact of the variable resistor R1 and varying the voltage Vr1, the voltage differential G1×(Vref1−Vr1) output by the differential amplifier OP1 can be varied, thereby finely adjusting the driving current Id1, and also finely adjusting the emission intensity of the semiconductor laser LD1 to a desired intensity. Thereby, the voltage Vr1 returns to an original value over a predetermined time constant, as described in the above.

To adjust the emission intensity of the semiconductor laser LD2, the controller CNT is instructed to switch the switching element SW1 to a non-conducting state and the switching element SW2 to a conducting state by using the control signals D1, D2.

By controlling the switching elements SW1, SW2 in this manner, a photoelectric current Ipd corresponding to the intensity of the light emitted by the semiconductor laser LD2 is generated in the monitor diode PD, and moreover, photocurrents I1, I2 formed by current division in proportion to the resistance values of the two variable resistors R1, R2 flow through the variable resistors R1, R2 respectively. Furthermore, equal voltage drops (I1×R1=I2×R2) occur at both ends of the variable resistors R1, R2.

Furthermore, at the movable contact of the variable resistor R1, a divided voltage Vr1 is generated which corresponds to the position of the movable contact, and similarly at the movable contact of the variable resistor R2, a divided voltage Vr2 is generated which corresponds to the position of this movable contact. Then, the divided voltage Vr1 is applied to the non-inversion input terminal of the differential amplifier OP1, and the divided voltage Vr2 is applied to the non-inversion input terminal of the differential amplifier OP2.

When the voltage Vr2 is applied to the differential amplifier OP2 in this manner, light emission from the semiconductor laser LD2 and light detection thereof by the monitor diode PD may be conducted in the following way. Namely, the differential amplifier OP2 compares the voltage Vr2 with the reference voltage Vref2 and then supplies the voltage differential G2×(Vref2−Vr2) to the power amplifier AMP2 via the switching element SW2, and the power amplifier AMP2 then supplies a driving current Id2 proportional to the voltage differential G2×(Vref2−Vr2) to the semiconductor laser LD2, thereby effecting the light emission from the semiconductor laser LD2 and light detection thereof by the monitor diode PD.

In contrast, although the differential amplifier OP1 compares the voltage Vr1 with the reference voltage Vref1 in a similar manner, and outputs the voltage differential G1×(Vref1×Vr1) to the switching element SW1, because the switching element SW1 is in a non-conducting state, the semiconductor laser LD1 is not supplied with the driving current Id1 and remains in a non-emitting state.

In this state, by finely adjusting the position of the movable contact of the variable resistor R2 and varying the voltage Vr2, the voltage differential G2×(Vref2−Vr2) output by the differential amplifier OP2 can be varied, thereby finely adjusting the driving current Id2, and also finely adjusting the emission intensity of the semiconductor laser LD2 to a desired intensity. Thereby, the voltage Vr2 returns to an original value over a predetermined time constant, as described in the above.

By controlling the switching of the switching elements SW1, SW2 in this manner, and finely adjusting the positions of the movable contacts of the variable resistors R1, R2, the driving currents (namely, the DC bias currents) Id1, Id2 of the semiconductor lasers LD1, LD2 produced by the automatic power control circuit APC can be adjusted to desired levels, and the emission intensities of the semiconductor lasers LD1, LD2 can be optimized for the optical writing of information to, or reading of information from, an information recording medium such as a CD or a DVD.

In particular, by finely adjusting the movable contact positions of the variable resistors R1, R2, the emission intensities of the semiconductor lasers LD1, LD2 can be adjusted both separately and accurately.

Then, after completion of the fine adjustments, when conducting information writing or information reading by using the semiconductor laser LD1, the switching element SW1 is set to a conducting state and the switching element SW2 to a non-conducting state, whereas when conducting information writing or information reading by using the semiconductor laser LD2, the switching element SW1 is set to a non-conducting state and the switching element SW2 to a conducting state.

In this manner, according to the automatic power control circuit APC of this third embodiment, even with a light source OG which is provided with only one monitor diode PD for two semiconductor lasers LD1, LD2, the emission intensities of the two semiconductor lasers LD1, LD2 can be finely adjusted, both separately and accurately, in accordance with the output from the monitor diode PD.

Furthermore, the switching element SW0 shown in the first and second embodiments is unnecessary, so that the size of the circuit can be reduced.

Furthermore, when the switching element SW0 shown in the first and second embodiments is formed using an analog switch, such as the case shown in FIG. 2, an ON resistance is generated and this ON resistance can affect the variable resistors R1, R2, thus making it difficult to accurately detect the photoelectric current Ipd generated in the monitor diode PD. In the third embodiment, the photoelectric current Ipd is detected as the voltage drop of only the two variable resistors R1, R2, so that adjustment of the driving currents Id1, Id2 of the semiconductor lasers LD1, LD2 can be performed more accurately than the first and second embodiments.

[Fourth Embodiment]

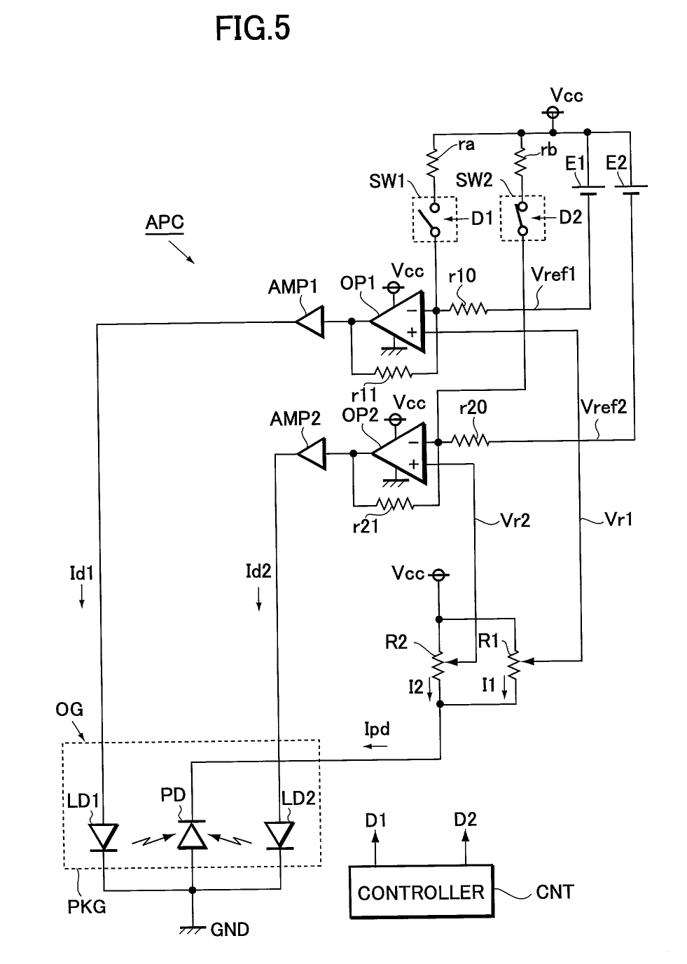

A fourth embodiment will be described below with reference to FIG. 5. In FIG. 5, components which are the same as, or correspond to, those of FIG. 4 will be represented by the same reference numerals.

FIG. 5 differs from FIG. 4, is that in the automatic power control circuit APC shown in FIG. 4 the switching elements SW1, SW2 are provided between the differential amplifiers OP1, OP2 and the power amplifiers AMP1, AMP2 respectively, in the automatic power control circuit APC of this embodiment, the switching elements SW1, SW2 are provided between a source voltage Vcc and the inversion input terminals of the differential amplifiers OP1, OP2 respectively.

In other words, the switching element SW1 is connected between the inversion input terminal of the differential amplifier OP1 and the source voltage Vcc via a resistor ra, and the switching element SW2 is connected between the inversion input terminal of the differential amplifier 0P2 and the source voltage Vcc via a resistor rb.

In an automatic power control circuit APC of this type according to the present embodiment, to adjust the emission intensity of the semiconductor laser LD1, the controller CNT is instructed to set the switching element to a non-conducting state, and the switching element SW2 to a conducting state by using the control signals D1, D2.

By controlling the switching of the switching elements SW1, SW2 in this manner, the potential at the inversion input terminal of the differential amplifier OP2 is larger than the potential at the inversion input terminal (the potential of the reference voltage Vref2), so that the differential amplifier OP2 switches to an OFF state, and as a result the semiconductor laser LD2 loses the supply of the driving current Id2 and therefore does not emit any light.

In contrast, the potential at the non-inversion input terminal of the differential amplifier OP1 is larger than the reference voltage Vref1, so that the differential amplifier OP1 switches to an operational state, and the semiconductor laser LD1 is supplied with a driving current Id1 proportional to the voltage differential (Vref1−Vr1) and therefore emits light. Then, a photoelectric current Ipd corresponding to the emission intensity of the semiconductor laser LD1 is generated in the monitor diode PD.

In this state, by finely adjusting the position of the movable contact of the variable resistor R1 and varying the voltage Vr1, the voltage differential G1×(Vref1−Vr1) output by the differential amplifier OP1 can be varied, thereby finely adjusting the driving current Id1, and also finely adjusting the emission intensity of the semiconductor laser LD1 to a desired intensity. Thereby, the voltage Vr1 returns to an original value over a predetermined time constant, as described in the above.

To adjust the emission intensity of the semiconductor laser LD2, the controller CNT is instructed to switch the switching element SW1 to a conducting state and the switching element SW2 to a non-conducting state by using the control signals D1, D2.

Thereby, the potential at the non-inversion input terminal of the differential amplifier OP1 is larger than the potential at the inversion input terminal (the potential of the reference voltage Vref1), so that the differential amplifier OP1 switches to an OFF state, and as a result the semiconductor laser LD1 loses the supply of the driving current Id1 and therefore does not emit any light.

In contrast, the potential at the non-inversion input terminal of the differential amplifier OP2 is larger than the reference voltage Vref2, so that the differential amplifier OP2 switches to an operational state, and the semiconductor laser LD2 is supplied with a driving current Id2 proportional to the voltage differential (Vref2−Vr2) and therefore emits light. Then, a photoelectric current Ipd corresponding to the emission intensity of the semiconductor laser LD2 is generated in the monitor diode PD.

In this state, by finely adjusting the position of the movable contact of the variable resistor R2 and varying the voltage Vr2, the voltage differential G2×(Vref2−Vr2) output by the differential amplifier OP2 can be varied, thereby finely adjusting the driving current Id2, and also finely adjusting the emission intensity of the semiconductor laser LD2 to a desired intensity. Thereby, the voltage Vr2 returns to an original value over a predetermined time constant, as described in the above.

By controlling the switching of the switching elements SW1, SW2 in this manner, and finely adjusting the positions of the movable contacts of each of the variable resistors R1, R2, the driving currents (namely, the DC bias currents) Id1, Id2 of the semiconductor lasers LD1, LD2 produced by the automatic power control circuit APC can be adjusted to desired levels, and the emission intensities of the semiconductor lasers LD1, LD2 can be “t” optimized for the optical writing of information to, or reading of information from, an information recording medium such as a CD or a DVD.

In particular, by fine adjustments of the movable contact positions of each of the variable resistors R1, R2, the emission intensities of the semiconductor lasers LD1, LD2 can be adjusted both separately and accurately.

Then, after completion of the fine adjustments, when conducting information writing or information reading by using the semiconductor laser LD1, the switching element SW1 is set to a non-conducting state and the switching element SW2 to a conducting state, whereas when conducting information writing or information reading by using the semiconductor laser LD2, the switching element SW1 is set to a conducting state and the switching element SW2 to a non-conducting state.

In this manner, according to the automatic power control circuit APC of this fourth embodiment, even with a light source OG which is provided with only one monitor diode PD for two semiconductor lasers LD1, LD2, the emission intensities of the two semiconductor lasers LD1, LD2 can be finely adjusted, both separately and accurately, in accordance with the output from the monitor diode PD.

[Fifth Embodiment]

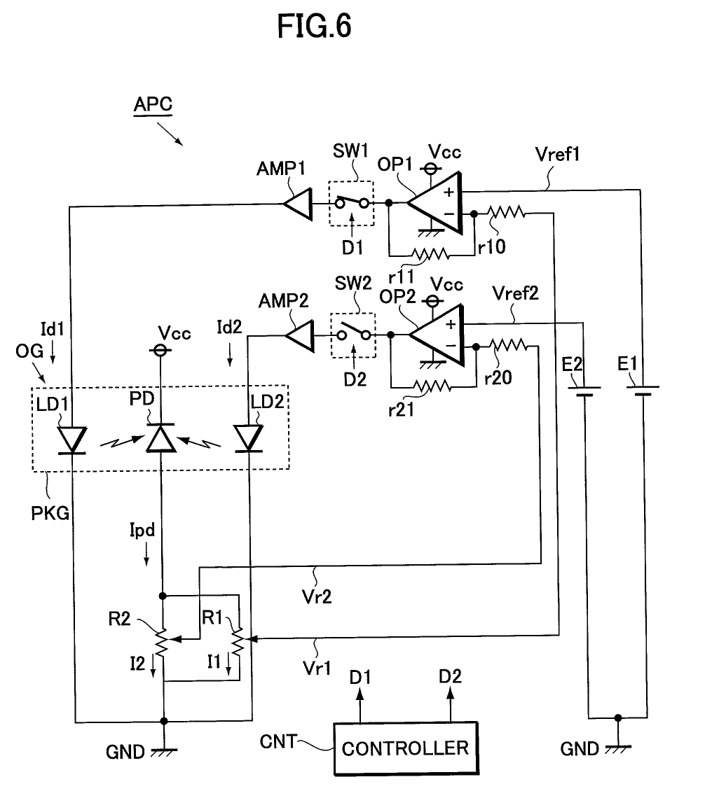

A fifth embodiment will be described below with reference to FIG. 6. In FIG. 6, components which are the same as, or correspond to, those of FIG. 4 will be represented by the same reference numerals.

FIG. 6 differs from FIG. 4 in that the cathodes of the semiconductor lasers LD1, LD2 are connected to a ground terminal GND, and the monitor diode PD is connected with reverse bias relative to the source voltage Vcc and the ground terminal GND.

Moreover, the anode of the monitor diode PD is connected to the ground terminal GND via the parallel connected variable resistors R1, R2, and the cathode is connected to the source voltage Vcc.

Furthermore, the movable contact of the variable resistor R1 is connected to the inversion input terminal of the differential amplifier OP1 via the resistor r10, and the movable contact of the variable resistor R2 is connected to the inversion input terminal of the differential amplifier OP2 via the resistor r20. The resistance value of the resistor r10 should be considerably larger than the resistance value of the variable resistor R1, and the resistance value of the resistor r20 should be considerably larger than the resistance value of the variable resistor R2. In other words, it is preferable that the settings satisfy the relationships r10>>R1, and r20>>R2.

Furthermore, the reference voltage Vref1 generated by the constant voltage source E1 is applied to the non-inversion input terminal of the differential amplifier OP1, and the reference voltage Vref2 generated by the constant voltage source E2 is applied to the non-inversion input terminal of the differential amplifier OP1.

In the automatic power control circuit APC of this type according to the present embodiment, to adjust the emission intensity of the semiconductor laser LD1, the controller CNT is instructed to set the switching element SW1 to a conducting state, and the switching element SW2 to a non-conducting state by using the control signals D1, D2.

By controlling the switching elements SW1, SW2 in this manner, a photoelectric current Ipd corresponding to the intensity of the light emitted by the semiconductor laser LD1 is generated in the monitor diode PD, and moreover, photocurrents I1, I2 formed by current division in proportion to the resistance values of the two variable resistors R1, R2 flow through the variable resistors R1, R2 respectively. Furthermore, equal voltage drops (I1×R=I2×R2) occur at both ends of the variable resistors R1, R2.

Furthermore, at the movable contact of the variable resistor R1, a divided voltage Vr1 is generated which corresponds to the position of the movable contact, and similarly at the movable contact of the variable resistor R2, a divided voltage Vr2 is generated which corresponds to the position of this movable contact. Then, the divided voltage Vr1 is applied to the inversion input terminal of the differential amplifier OP1 via the resistor r10, and the divided voltage Vr2 is applied to the inversion input terminal of the differential amplifier OP2 via the resistor r20.

When the voltage Vr1 is applied to the differential amplifier OP1 in this manner, light emission from the semiconductor laser LD1 and light detection thereof by the monitor diode PD may be conducted in the following way. Namely, the differential amplifier OP1 compares the voltage Vr1 with the reference voltage Vref1 and then supplies the voltage differential G1×(Vref1−Vr1) to the power amplifier AMP1 via the switching element SW1, and the power amplifier AMP1 then supplies a driving current Id1 proportional to the voltage differential G1×(Vref1−Vr1) to the semiconductor laser LD1, thereby effecting the light emission from the semiconductor laser LD1 and light detection thereof by the monitor diode PD.

In contrast, although the differential amplifier OP2 compares the voltage Vr2 with the reference voltage Vref2 in a similar manner, and outputs the voltage differential G2×(Vref2−Vr2) to the switching element SW2, because the switching element SW2 is in a non-conducting state, the semiconductor laser LD2 is not supplied with the driving current Id2 and remains in a non-emitting state.

In this state, by finely adjusting the position of the movable contact of the variable resistor R1 and varying the voltage Vr1, the voltage differential G1×(Vref1−Vr1) output by the differential amplifier OP1 can be varied, thereby finely adjusting the driving current Id1, and also finely adjusting the emission intensity of the semiconductor laser LD1 to a desired intensity. Thereby, the voltage Vr1 returns to an original value over a predetermined time constant, as described in the above.

To adjust the emission intensity of the semiconductor laser LD2, the controller CNT is instructed to switch the switching element SW1 to a non-conducting state and the switching element SW2 to a conducting state by using the control signals D1, D2.

By controlling the switching elements SW1, SW2 in this manner, a photoelectric current Jpd corresponding to the intensity of the light emitted by the semiconductor laser LD2 is generated in the monitor diode PD, and moreover, photocurrents I1, I2 formed by current division in proportion to the resistance values of the two variable resistors R1, R2 flow through the variable resistors R1, R2 respectively. Furthermore, equal voltage drops (I1×R=I2×R2) occur at both ends of the variable resistors R1, R2.

Furthermore, at the movable contact of the variable resistor R1, a divided voltage Vr1 is generated which corresponds to the position of the movable contact, and similarly at the movable contact of the variable resistor R2, a divided voltage Vr2 is generated which corresponds to the position of this movable contact. Then, the divided voltage Vr1 is applied to the inversion input terminal of the differential amplifier OP1, and the divided voltage Vr2 is applied to the inversion input terminal of the differential amplifier OP2.

When the voltage Vr2 is applied to the differential amplifier OP2 in this manner, light emission from the semiconductor laser LD2 and light detection thereof by the monitor diode PD may be conducted in the following way. Namely, the differential amplifier OP2 compares the voltage Vr2 with the reference voltage Vref2 and then supplies the voltage differential G2×(Vref2−Vr2) to the power amplifier AMP2 via the switching element SW2, and the power amplifier AMP2 then supplies a driving current Id2 proportional to the voltage differential G2×(Vref2−Vr2) to the semiconductor laser LD2, thereby effecting the light emission from the semiconductor laser LD2 and light detection thereof by the monitor diode PD.

In contrast, although the differential amplifier OP1 compares the voltage Vr1 with the reference voltage Vref1 in a similar manner, and outputs the voltage differential G1×(Vref1−Vr1) to the switching element SW1, because the switching element SW1 is in a non-conducting state, the semiconductor laser LD1 is not supplied with the driving current Id1 and remains in a non-emitting state.

In this state, by finely adjusting the position of the movable contact of the variable resistor R2 and varying the voltage Vr2, the voltage differential G2×(Vref2−Vr2) output by the differential amplifier OP2 can be varied, thereby finely adjusting the driving current Id2, and also finely adjusting the emission intensity of the semiconductor laser LD2 to a desired intensity. Thereby, the voltage Vr2 returns to an original value over a predetermined time constant, as described in the above.

By controlling the switching of the switching elements SW1 SW2 in this manner, and finely adjusting the positions of the movable contacts of each of the variable resistors R1, R2, the driving currents (namely, the DC bias currents) Id1, Id2 of the semiconductor lasers LD1, LD2 produced by the automatic power control circuit APC can be adjusted to desired levels, and the emission intensities of the semiconductor lasers LD1, LD2 can be optimized for the optical writing of information to, or reading of information from, an information recording medium such as a CD or a DVD.

In particular, by fine adjustments of the movable contact position of each of the variable resistors R1, R2, the emission intensities of the semiconductor lasers LD1, LD2 can be adjusted both separately and accurately.

Then, after completion of the fine adjustments, when conducting information writing or information reading by using the semiconductor laser LD1, the switching element SW1 is set to a conducting state and the switching element SW2 to a non-conducting state, whereas when conducting information writing or information reading by using the semiconductor laser LD2, the switching element SW1 is set to a non-conducting state and the switching element SW2 to a conducting state.

In this manner, according to the automatic power control circuit APC of this fifth embodiment, even with a light source OG which is provided with only one monitor diode PD for two semiconductor lasers LD1, LD2, the emission intensities of the two semiconductor lasers LD1, LD2 can be finely adjusted, both separately and accurately, in accordance with the output from the monitor diode PD.

[Sixth Embodiment]

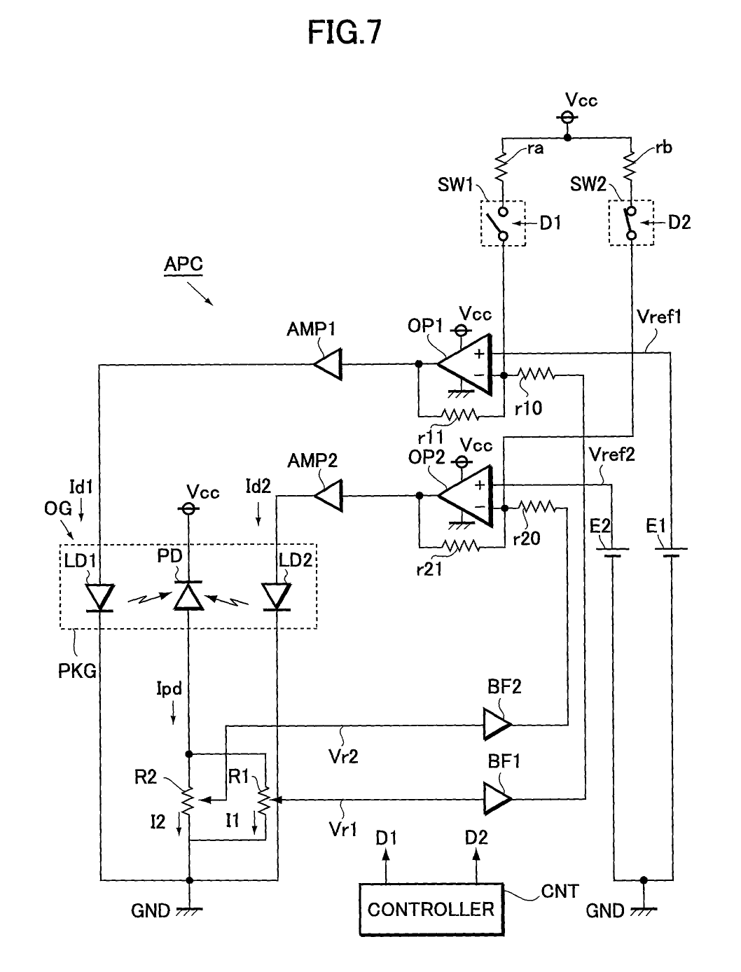

Next a sixth embodiment will be described with reference to FIG. 7. In FIG. 7, components which are the same as, or correspond to, those of FIG. 6 will be represented by the same reference numerals.

F FIG. 7 differs from FIG. 6, is that in the automatic power control circuit APC shown in FIG. 6 the switching elements SW1, SW2 are provided between the differential amplifiers OP1, OP2 and the power amplifiers AMP1, AMP2 respectively, in the automatic power control circuit APC of this embodiment, the switching elements SW1, SW2 are provided between a source voltage Vcc and the inversion input terminals of the differential amplifiers OP1, OP2 respectively.

In other words, the switching element SW1 is connected between the inversion input terminal of the differential amplifier OP1 and the source voltage Vcc via a resistor ra, and the switching element SW2 is connected between the inversion input terminal of the differential amplifier OP2 and the source voltage Vcc via a resistor rb.

Furthermore, the voltage Vr1 which is generated at the movable contact of the variable resistor R1 is supplied to the differential amplifier OP1 via a buffer amplifier BF1, and the voltage Vr2 which is generated at the movable contact of the variable resistor R2 is supplied to the differential amplifier OP2 via a buffer amplifier BF2.

In the automatic power control circuit APC of this type according to the present invention, to adjust the emission intensity of the semiconductor laser LD1, the controller CNT is instructed to set the switching element SW1 to a non-conducting state, and the switching element SW2 to a conducting state by using the control signals D1, D2.

By controlling the switching elements SW1, SW2 in this manner, a photoelectric current Ipd corresponding to the intensity of the light emitted by the semiconductor laser LD1 is generated in the monitor diode PD, and moreover, photocurrents I1, I2 formed through current division in proportion to the resistance values of the two variable resistors R1, R2 flow through the variable resistors R1, R2 respectively. Furthermore, equal voltage drops (I1 ×R1=I2×R2) occur at both ends of the variable resistors R1, R2.

In addition, at the movable contact of the variable resistor R1, a divided voltage Vr1 is generated which corresponds to the position of the movable contact, and similarly at the movable contact of the variable resistor R2, a divided voltage Vr2 is generated which corresponds to the position of this movable contact. Then, the divided voltage Vr1 is applied to the inversion input terminal of the differential amplifier OP1 via the resistor r10, and the divided voltage Vr2 is applied to the inversion input terminal of the differential amplifier OP2 via the resistor r20.

When the voltage Vr1 is applied to the differential amplifier OP1 in this manner, light emission from the semiconductor laser LD1 and light detection thereof by the monitor diode PD may be conducted in the following way. Namely, the differential amplifier OP1 compares the voltage Vr1 with the reference voltage Vref1 and then supplies the voltage differential G1×(Vref1−Vr1) to the power amplifier AMP1, and the power amplifier AMP1 then supplies a driving current Id1 proportional to the voltage differential G1×(Vref1−Vr1) to the semiconductor laser LD1, thereby effecting the light emission from the semiconductor laser LD1 and light detection thereof by the monitor diode PD.

In contrast, in the case of the differential amplifier OP2, the potential at the inversion input terminal is larger than the reference voltage Vref2 so that the differential amplifier OP2 switches to an OFF state. As a result, the semiconductor laser LD2 is not supplied with the driving current Id2 and shifts to a non-emitting state.

In this state, by finely adjusting the position of the movable contact of the variable resistor R1 and varying the voltage Vr1, the voltage differential G1×(Vref1−Vr1) output by the differential amplifier OP1 can be varied, thereby finely adjusting the driving current Id1, and also finely adjusting the emission intensity of the semiconductor laser LD1 to a desired intensity. Thereby, the voltage Vr1 returns to an original value over a predetermined time constant, as described in the above.

To adjust the emission intensity of the semiconductor laser LD2, the controller CNT is instructed to switch the switching element SW1 to a conducting state and the switching element SW2 to a non-conducting state by using the control signals D1, D2.

By controlling the switching elements SW1, SW2 in this manner, a photoelectric current Ipd corresponding to the intensity of the light emitted by the semiconductor laser LD2 is generated in the monitor diode PD, and moreover, photocurrents I1, I2 formed through current division in proportion to the resistance values of the two variable resistors R1, R2 flow through the variable resistors R1, R2 respectively. Furthermore, an equal voltage drop (I1×R1=I2×R2) is generated at both ends of the variable resistors R1, R2.

In addition, at the movable contact of the variable resistor R1, a divided voltage Vr1 is generated which corresponds to the position of the movable contact, and similarly at the movable contact of the variable resistor R2, a divided voltage Vr2 is generated which corresponds to the position of this movable contact. Then, the divided voltage Vr1 is applied to the inversion input terminal of the differential amplifier OP1, and the divided voltage Vr2 is applied to the inversion input terminal of the differential amplifier OP2.

When the voltage Vr2 is applied to the differential amplifier OP2 in this manner, light emission from the semiconductor laser LD2 and light detection thereof by the monitor diode PD may be conducted in the following way. Namely, the differential amplifier OP2 compares the voltage Vr2 with the reference voltage Vref2 and then supplies the voltage differential G2×(Vref2−Vr2) to the power amplifier AMP2, and the power amplifier AMP2 then supplies a driving current Id2 proportional to the voltage differential G2×(Vref2−Vr2) to the semiconductor laser LD2, thereby effecting the light emission from the semiconductor laser LD2 and light detection thereof by the monitor diode PD.

In contrast, in the case of the differential amplifier OP1, the potential at the inversion input terminal is larger than the reference voltage Vref1 and so the differential amplifier OP1 switches to an OFF state, and as a result, the semiconductor laser LD1 is not supplied with the driving current Id1 and shifts to a non-emitting state.

In this state, by finely adjusting the position of the movable contact of the variable resistor R2 and varying the voltage Vr2, the voltage differential G2×(Vref2−Vr2) output by the differential amplifier OP2 can be varied, thereby finely adjusting the driving current Id2, and also finely adjusting the emission intensity of the semiconductor laser LD2 to a desired intensity. Thereby, the voltage Vr2 returns to an original value over a predetermined time constant, as described in the above.

By controlling the switching of the switching elements SW1, SW2 in this manner, and finely adjusting the positions of the movable contacts of each of the variable resistors R1, R2, the driving currents (namely, the DC bias currents) Id1, Id2 of the semiconductor lasers LD1, LD2 produced by the automatic power control circuit APC can be adjusted to desired levels, and the emission intensities of the semiconductor lasers LD1, LD2 can be optimized for the optical writing of information to, or reading of information from, an information recording medium such as a CD or a DVD.

In particular, by fine adjustments of the movable contact position of each of the variable resistors R1, R2, the emission intensities of the semiconductor lasers LD1, LD2 can be adjusted both separately and accurately.

Then, after completion of the fine adjustments, when conducting information writing or information reading by using the semiconductor laser LD1, the switching element SW1 is set to a non-conducting state and the switching element SW2 to a conducting state, whereas when conducting information writing or information reading by using the semiconductor laser LD2, the switching element SW1 is set to a conducting state and the switching element SW2 to a non-conducting state.

In this manner, according to the automatic power control circuit APC of this sixth embodiment, even with a light source OG which is provided with only one monitor diode PD for two semiconductor lasers LD1, LD2, the emission intensities of the two semiconductor lasers LD1, LD2 can be finely adjusted, both separately and accurately, in accordance with the output from the monitor diode PD.

[Seventh Embodiment]

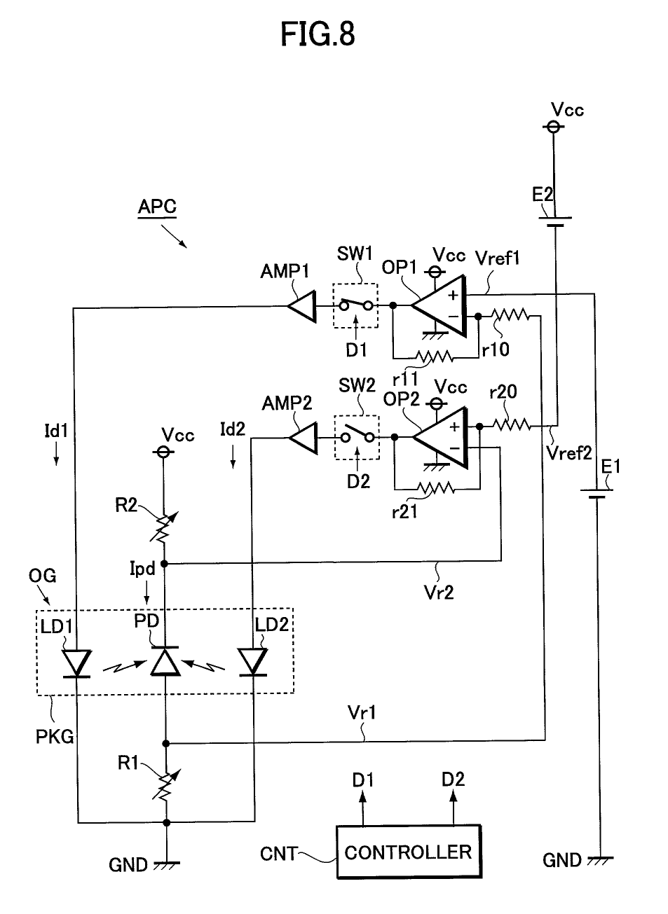

A seventh embodiment will be described below with reference to FIG. 8. In FIG. 8, components which are the same as, or correspond to, those of FIG. 6 are represented by the same reference numerals.

FIG. 8 differs from FIG. 6, in that in the automatic power control circuit APC shown in FIG. 6, the anode of the monitor diode PD is connected to the parallelly connected variable resistors R1, R2, whereas in the automatic power control circuit APC of this embodiment, the anode of the monitor diode PD is connected to the ground terminal GND via the variable resistor R1, and the cathode of the monitor diode PD is connected to the source voltage Vcc via the variable resistor R2.

Furthermore, the point of connection between the anode of the monitor diode PD and the variable resistor R1 is connected to the inversion input terminal of the differential amplifier OP1 via the resistor r10, and the point of connection between the cathode of the monitor diode PD and the variable resistor R2 is connected to the inversion input terminal of the differential amplifier OP2.

Furthermore, a reference voltage Vref1 equal to the constant voltage source E1 is applied to the non-inversion input terminal of the differential amplifier OP1, and a reference voltage Vref2 which is lower than the source voltage Vcc by an amount equivalent to the constant voltage source E2, is applied to the non-inversion input terminal of the differential amplifier OP2.

In the automatic power control circuit of this type according to the present embodiment, to adjust the emission intensity of the semiconductor laser LD1, the controller CNT is instructed to switch the switching element SW1 to a conducting state and the switching element SW2 to a non-conducting state by using the control signals D1, D2.

By controlling the switching elements SW1, SW2 in this manner, the semiconductor laser LD2 is not supplied with the driving current Id2 and so shifts to a non-emitting state, and a photoelectric current Ipd corresponding to the intensity of the light emitted from the semiconductor laser LD1 is generated in the monitor diode PD. Moreover, voltage drops Vr1, Vr2 corresponding to the resistance values of the variable resistors R1, R2 are generated in the variable resistors R1, R2 respectively, the voltage Vr1 is applied to the inversion input terminal of the differential amplifier OP1, and the voltage Vr2 is applied to the inversion input terminal of the differential amplifier OP2.

In this state, by finely adjusting the resistance value of the variable resistor R1 and varying the voltage Vr1, the voltage differential G1×(Vref1−Vr1) output by the differential amplifier OP1 can be varied, thereby finely adjusting the driving current Id1, and also finely adjusting the emission intensity of the semiconductor laser LD1 to a desired intensity. Thereby, the voltage Vr1 returns to an original value over a predetermined time constant, as described in the above.

To adjust the emission intensity of the semiconductor laser LD2, the controller CNT is instructed to switch the switching element SW1 to a non-conducting state and the switching element SW2 to a conducting state by using the control signals D1, D2.

By controlling the switching elements SW1, SW2 in this manner, the semiconductor laser LD1 is not supplied with the driving current Id1 and so shifts to a non-emitting state, and a photoelectric current Ipd corresponding to the intensity of the light emitted from the semiconductor laser LD2 is generated in the monitor diode PD. Moreover, voltage drops Vr1, Vr2 corresponding to the resistance values of the variable resistors R1, R2 are generated in the variable resistors R1, R2 respectively.

In this state, by finely adjusting the resistance value of the variable resistor R2 and varying the voltage Vr2, the voltage differential G2×(Vref2−Vr2) output by the differential amplifier OP2 can be varied, thereby finely adjusting the driving current Id2, and also finely adjusting the emission intensity of the semiconductor laser LD2 to a desired intensity. Thereby, the voltage Vr2 returns to an original value over a predetermined time constant, as described in the above.

By controlling the switching of the switching elements SW1, SW2 in this manner, and finely adjusting the resistance values of each of the variable resistors R1, R2, the driving currents (namely, the DC bias currents) Id1, Id2 of the semiconductor lasers LD1, LD2 produced by the automatic power control circuit APC can be adjusted to desired levels, and the emission intensities of the semiconductor lasers LD1, LD2 can be optimized for the optical writing of information to, or reading of information from, an information recording medium such as a CD or a DVD.

In particular, by fine adjustments of each resistance value of the variable resistors R1, R2, the emission intensities of the semiconductor lasers LD1, LD2 can be adjusted both separately and accurately.

Then, after completion of the fine adjustments, when conducting information writing or information reading by using the semiconductor laser LD1, the switching element SW1 is set to a conducting state and the switching element SW2 to a non-conducting state, whereas when conducting information writing or information reading by using the semiconductor laser LD2, the switching element SW1 is set to a non-conducting state and the switching element SW2 to a conducting state.

In this manner, according to the automatic power control circuit APC of this seventh embodiment, even with a light source OG which is provided with only one monitor diode PD for two semiconductor lasers LD1, LD2, the emission intensities of the two semiconductor lasers LD1, LD2 can be finely adjusted, both separately and accurately, in accordance with the output from the monitor diode PD.

[Eighth Embodiment]

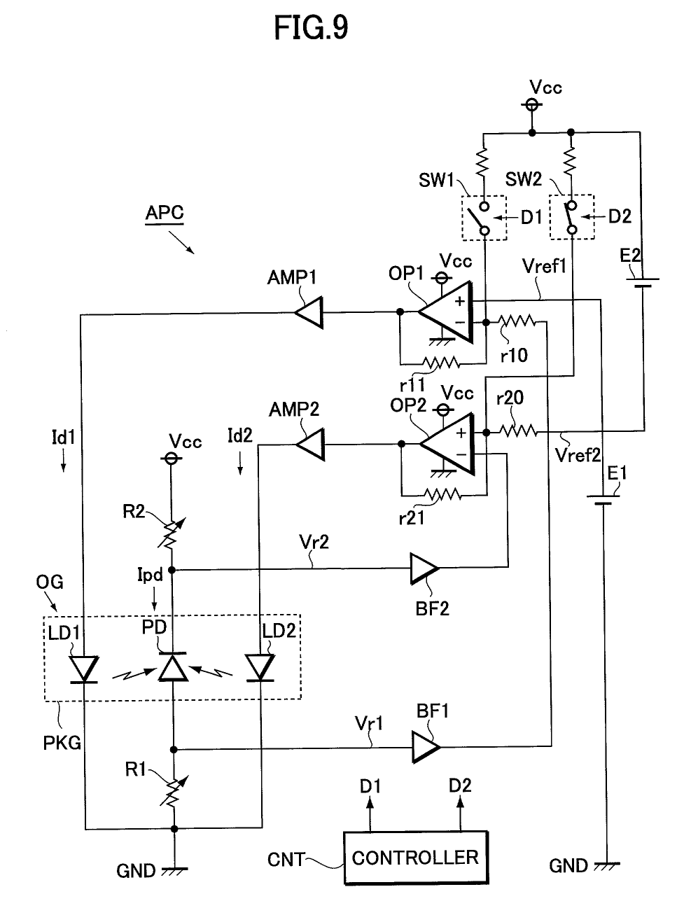

An eighth embodiment will be described below with reference to FIG. 9. In FIG. 9, components which are the same as, or correspond to, those of FIG. 8 are represented by the same reference numerals.

FIG. 9 differs from FIG. 8, in that in the automatic power control circuit APC shown in FIG. 8 the switching elements SW1, SW2 are provided between the differential amplifiers OP1, OP2 and the power amplifiers AMP1, AMP2 respectively, whereas in the automatic power control circuit APC of this embodiment, the switching elements SW1, SW2 are provided between the source voltage Vcc and the inversion input terminals of the differential amplifiers OP1, OP2. Furthermore, the voltage Vr1 which is generated in the variable resistor R1 is supplied to the differential amplifier OP1 via the buffer amplifier BF1, and the voltage Vr2 which is generated in the variable resistor R2 is supplied to the differential amplifier OP2 via a buffer amplifier BF2.

In this type of construction, to adjust the emission intensity of the semiconductor laser LD1, the controller CNT is instructed to switch the switching element SW1 to a non-conducting state and the switching element SW2 to a conducting state by using the control signals D1, D2.

By controlling the switching elements SW1, SW2 in this manner, the semiconductor laser LD2 is not supplied with the driving current Id2 and so shifts to a non-emitting state, and a photoelectric current Ipd corresponding to the intensity of the light emitted from the semiconductor laser LD1 is generated in the monitor diode PD. Moreover, voltage drops Vr1, Vr2 corresponding to the resistance values of the variable resistors R1, R2 are generated in the variable resistors R1, R2 respectively.

In this state, by finely adjusting the resistance value of the variable resistor R1 and varying the voltage Vr1, the voltage differential G1×(Vref1−Vr1) output by the differential amplifier OP1 can be varied, thereby finely adjusting the driving current Id1, and also finely adjusting the emission intensity of the semiconductor laser LD1 to a desired intensity. Thereby, the voltage Vr1 returns to an original value over a predetermined time constant, as described in the above.

To adjust the emission intensity of the semiconductor laser LD2, the controller CNT is instructed to switch the switching element SW1 to a conducting state and the switching element SW2 to a non-conducting state by using the control signals D1, D2.

By controlling the switching elements SW1, SW2 in this manner, the semiconductor laser LD1 is not supplied with the driving current Id1 and so shifts to a non-emitting state, and a photoelectric current Ipd corresponding to the intensity of the light emitted from the semiconductor laser LD2 is generated in the monitor diode PD. Moreover, voltage drops Vr1, Vr2 corresponding to the resistance values of the variable resistors R1, R2 are generated in the variable resistors R1, R2 respectively.

In this state, by finely adjusting the resistance value of the variable resistor R2 and varying the voltage Vr2, the voltage differential G2×(Vref2−Vr2) output by the differential amplifier OP2 can be varied, thereby finely adjusting the driving current Id2, and also finely adjusting the emission intensity of the semiconductor laser LD2 to a desired intensity. Thereby, the voltage Vr2 returns to an original value over a predetermined time constant, as described in the above.

ByBy controlling the switching of the switching elements SW1, SW2 in this manner, and finely adjusting the resistance values of each of the variable resistors R1, R2, the driving currents (namely, the DC bias currents) Id1, Id2 of the semiconductor lasers LD1, LD2 produced by the automatic power control circuit APC can be adjusted to desired levels, and the emission intensities of the semiconductor lasers LD1, LD2 can be optimized for the optical writing of information to, or reading of information from, an information recording medium such as a CD or a DVD.

In particular, by fine adjustments of each resistance value of the variable resistors R1, R2, the emission intensities of the semiconductor lasers LD1, LD2 can be adjusted both separately and accurately.

Then, after completion of the fine adjustments, when conducting information writing or information reading by using the semiconductor laser LD1, the switching element SW1 is set to a non-conducting state and the switching element SW2 to a conducting state, whereas when conducting information writing or information reading by using the semiconductor laser LD2, the switching element SW1 is set to a conducting state and the switching element SW2 to a non-conducting state.

In this manner, according to the automatic power control circuit APC of this eighth embodiment, even with a light source OG which is provided with only one monitor diode PD for two semiconductor lasers LD1, LD2, the emission intensities of the two semiconductor lasers LD1, LD2 can be finely adjusted, separately and accurately, in accordance with the output from the monitor diode PD.

[Ninth Embodiment]

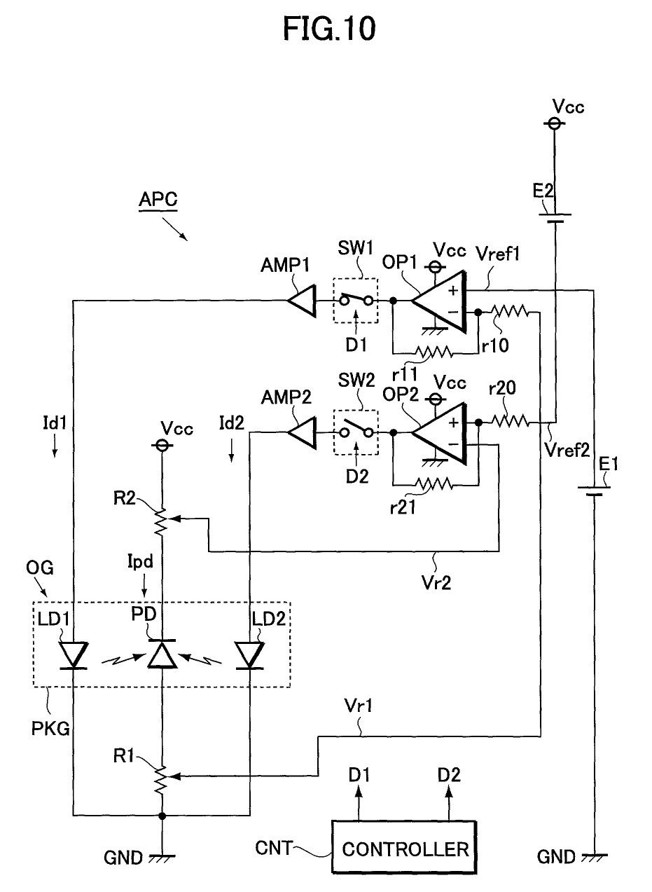

Next, a ninth embodiment will be described with reference to FIG. 10. In FIG. 10, components which are the same as, or correspond to, those of FIG. 8 are represented by the same reference numerals.

FIG. 10 differs from FIG. 8 in that in the automatic power control circuit APC shown in FIG. 8 the variable resistors R1, R2 are connected in series relative to the monitor diode PD and the voltages Vr1, Vr2 which are generated at the anode and cathode respectively of the monitor diode PD are supplied to the inversion input terminals of the differential amplifiers OP1, OP2 respectively, whereas in the automatic power control circuit APC of this embodiment, the voltages Vr1, Vr2 which are generated at the movable contacts of the variable resistors R1, R2 respectively are supplied to the inversion input terminals of the differential amplifiers OP1, OP2 respectively.

In the automatic power control circuit APC of this type according to the present embodiment, to adjust the emission intensity of the semiconductor laser LD1, the controller CNT is instructed to switch the switching element SW1 to a conducting state and the switching element SW2 to a non-conducting state by using the control signals D1, D2.

By controlling the switching elements SW1, SW2 in this manner, the semiconductor laser LD2 is not supplied with the driving current Id2 and so shifts to a non-emitting state, and a photoelectric current Ipd corresponding to the intensity of the light emitted from the semiconductor laser LD1 is generated in the monitor diode PD. Moreover, voltage drops Vr1, Vr2 corresponding to the positions of the movable contacts of the variable resistors R1, R2 respectively are generated in the variable resistors R1, R2 respectively, and the voltage Vr1 is applied to the inversion input terminal of the differential amplifier OP1, and the voltage Vr2 is applied to the inversion input terminal of the differential amplifier OP2.

In this state, by finely adjusting the position of the movable contact of the variable resistor R1 and varying the voltage VrI, the voltage differential G1×(Vref1−Vr1) output by the differential amplifier OP1 can be varied, thereby finely adjusting the driving current Id1, and also finely adjusting the emission intensity of the semiconductor laser LD1 to a desired intensity. Thereby, the voltage Vr1 returns to an original value over a predetermined time constant, as described in the above.

To adjust the emission intensity of the semiconductor laser LD2, the controller CNT is instructed to switch the switching element SW1 to a non-conducting state and the switching element SW2 to a conducting state by using the control signals D1, D2.

By controlling the switching elements SW1, SW2 in this manner, the semiconductor laser LD1 is not supplied with the driving current Id1 and so shifts to a non-emitting state, and a photoelectric current Ipd corresponding to the intensity of the light emitted from the semiconductor laser LD2 is generated in the monitor diode PD. Moreover, voltage drops Vr1, Vr2 corresponding to the resistance values of the variable resistors R1, R2 are generated in the variable resistors R1, R2 respectively.

In this state, by finely adjusting the position of the movable contact of the variable resistor R2 and varying the voltage Vr2, the voltage differential G2×(Vref2−Vr2) output by the differential amplifier OP2 can be varied, thereby finely adiusting the driving current Id2, and also finely adjusting the emission intensity of the semiconductor laser LD2 to a desired intensity. Thereby, the voltage Vr2 returns to an original value over a predetermined time constant, as described in the above.

By controlling the switching of the switching elements SW1, SW2 in this manner, and finely adjusting the positions of the movable contacts of each of the variable resistors R1, R2, the driving currents (namely, the DC bias currents) Id1, Id2 of the semiconductor lasers LD1, LD2 produced by the automatic power control circuit APC can be adjusted to desired levels, and the emission intensities of the semiconductor lasers LD1, LD2 can be optimized for the optical writing of information to, or reading of information from, an information recording medium such as a CD or a DVD.

In particular, even if each of the positions of the movable contacts of the variable resistors R1, R2 connected in series to the photodiode PD are varied, the resistance values of the variable resistors R1, R2 relative to the photodiode PD will not change, and so the bias current Id of the photodiode PD can be maintained at a constant value. As a result, the sensitivity of the photodiode PD can be maintained at a constant level, and the emission intensities of the semiconductor lasers LD1, LD2 can be adjusted both separately and accurately.

Then, after completion of the fine adjustments, when conducting information writing or information reading by using the semiconductor laser LD1, the switching element SW1 is set to a conducting state and the switching element SW2 to a non-conducting state, whereas when conducting information writing or information reading by using the semiconductor laser LD2, the switching element SW1 is set to a non-conducting state and the switching element SW2 to a conducting state.

In this manner, according to the automatic power control circuit APC of this ninth embodiment, even with a light source OG which is provided with only one monitor diode PD for two semiconductor lasers LD1, LD2, the emission intensities of the two semiconductor lasers LD1, LD2 can be finely adjusted, both separately and accurately, in accordance with the output from the monitor diode PD.

[Tenth Embodiment]

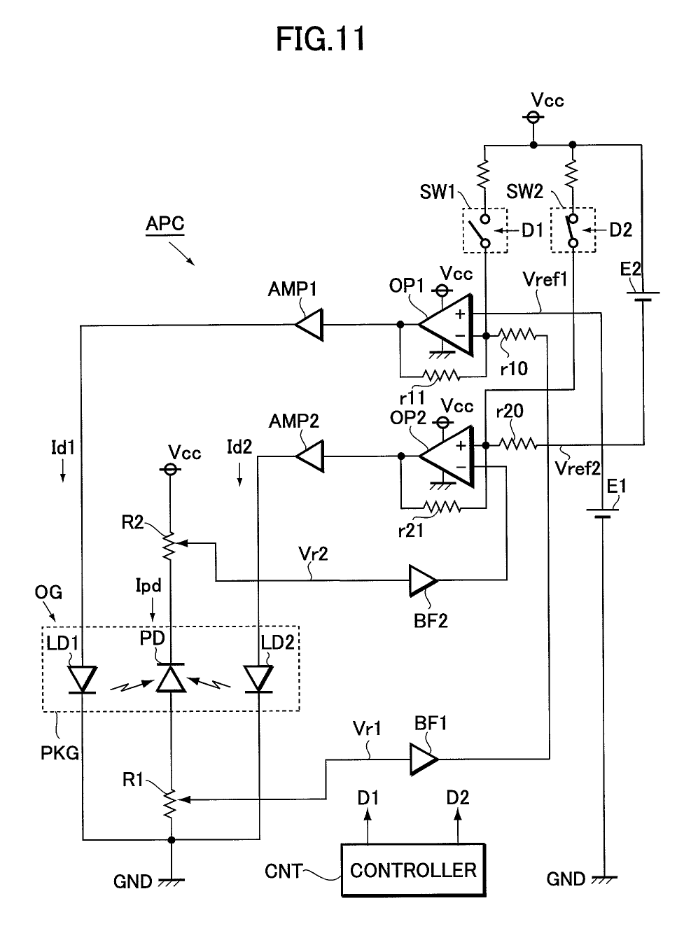

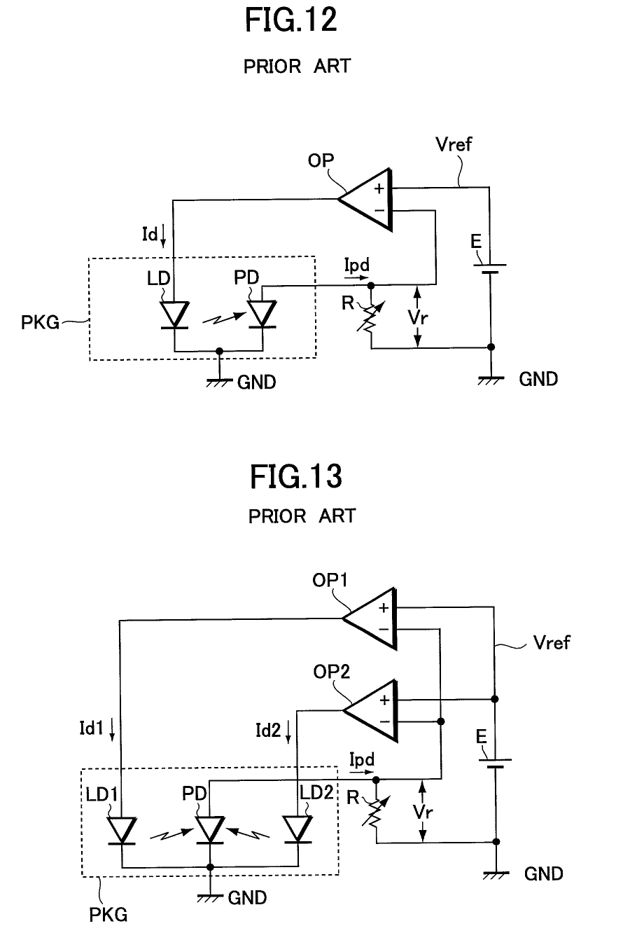

A tenth embodiment will be described below with reference to FIG. 11. In FIG. 11, components which are the same as, or correspond to, those of FIG. 10 are represented by the same reference numerals.

FIG. 11 differs from FIG. 10, in that in the automatic power control circuit APC shown in FIG. 10, the switching elements SW1, SW2 are provided between the differential amplifiers OP1, OP2 and the power amplifiers AMP1, AMP2 respectively, whereas in the automatic power control circuit APC of this embodiment, the switching elements SW1, SW2 are provided between the source voltage Vcc and the inversion input terminals of the differential amplifiers OP1, OP2. Furthermore, the voltage Vr1 which is generated at the movable contact point of the variable resistor R1 is supplied to the differential amplifier OP1 via the buffer amplifier BF1, and the voltage Vr2 which is generated at the movable contact point of the variable resistor R2 is supplied to the differential amplifier OP2 via the buffer amplifier BF2.

In this type of construction, to adjust the emission intensity of the semiconductor laser LD1, the controller CNT is instructed to switch the switching element SW1 to a non-conducting state and the switching element SW2 to a conducting state by using the control signals D1, D2.

By controlling the switching elements SW1, SW2 in this manner, the semiconductor laser LD2 is not supplied with the driving current Id2 and so shifts to a non-emitting state, and a photoelectric current Ipd corresponding to the intensity of the light emitted from the semiconductor laser LD1 is generated in the monitor diode PD. Moreover, voltage drops Vr1, Vr2 corresponding to the positions of the movable contacts of the variable resistors R1, R2 are generated in the variable resistors R1, R2 respectively, and the voltage Vr1 is applied to the inversion input terminal of the differential amplifier OP1, and the voltage Vr2 is applied to the inversion input terminal of the differential amplifier OP2.

In this state, by finely adjusting the position of the movable contact of the variable resistor R1 and varying the voltage Vr1, the voltage differential G1×(Vref1−Vr1) output by the differential amplifier OP1 can be varied, thereby finely adjusting the driving current Id1, and also finely adjusting the emission intensity of the semiconductor laser LD1 to a desired intensity. Thereby, the voltage Vr1 returns to an original value over a predetermined time constant, as described in the above.

To adjust the emission intensity of the semiconductor laser LD2, the controller CNT is instructed to switch the switching element SW1 to a conducting state and the switching element SW2 to a non-conducting state by using the control signals D1, D2 are used.

By controlling the switching elements SW1, SW2 in this manner, the semiconductor laser LD1 is not supplied with the driving current Id1 and so shifts to a non-emitting state, and a photoelectric current Ipd corresponding to the intensity of the light emitted from the semiconductor laser LD2 is generated in the monitor diode PD. Moreover, voltage drops Vr1, Vr2 corresponding to the positions of the movable contacts of the variable resistors R1, R2 are generated in the variable resistors R1, R2 respectively.

In this state, by finely adjusting the position of the movable contact of the variable resistor R2 and varying the voltage Vr2, the voltage differential G2×(Vref2−Vr2) output by the differential amplifier OP2 can be varied, thereby finely adjusting the driving current Id2, and also finely adjusting the emission intensity of the semiconductor laser LD2 to a desired intensity. Thereby, the voltage Vr2 returns to an original value over a predetermined time constant, as described in the above.

By controlling the switching of the switching elements SW1, SW2 in this manner, and finely adjusting the positions of the movable contacts of each of the variable resistors R1, R2, the driving currents (namely, the DC bias currents) Id1, Id2 of the semiconductor lasers LD1, LD2 produced by the automatic power control circuit APC can be adjusted to desired levels, and the emission intensities of the semiconductor lasers LD1, LD2 can be optimized for the optical writing of information to, or reading of information from, an information recording medium such as a CD or a DVD.

In particular, even if each of the positions of the movable contacts of the variable resistors R1, R2 connected in series to the photodiode PD are varied, the resistance values of the variable resistors R1, R2 relative to the photodiode PD will not change, and so the bias current Id of the photodiode PD can be maintained at a constant value. As a result, the sensitivity of the photodiode PD can be maintained at a constant level, and the emission intensities of the semiconductor lasers LD1, LD2 can be adjusted both separately and accurately.

Then, after completion of the fine adjustments, when conducting information writing or information reading by using the semiconductor laser LD1, the switching element SW1 is set to a non-conducting state and the switching element SW2 to a conducting state, whereas when conducting information writing or information reading by using the semiconductor laser LD2, the switching element SW1 is set to a conducting state and the switching element SW2 to a non-conducting state.

In this manner, according to the automatic power control circuit APC of this tenth embodiment, even with a light source OG which is provided with only one monitor diode PD for two semiconductor lasers LD1, LD2, the emission intensities of the two semiconductor lasers LD1, LD2 can be finely adjusted, separately and accurately, in accordance with the output from the monitor diode PD.

In the above first to tenth embodiments of the present invention, descriptions are focused on the cases where the emission intensities of two semiconductor lasers LD1, LD2 were detected by a single monitor diode PD, but the present invention is not limited to the control of only two semiconductor lasers, and can also be applied to the control of more than two semiconductor lasers.

Furthermore, the invention is also not limited to the control of semiconductor lasers, and can also be used for controlling the emission intensity of light emitting diodes. In conclusion, the present invention can be applied generally to all types of light emitting elements. As a result, the present invention is not limited to applications comprising optical pickups and may also be applied to devices such as printers and scanners.

As may be understood from the above descriptions, according to the present invention, there is provided an automatic power control circuit comprising a plurality of light emitting elements and a light detecting element for detecting a portion of the light emitted from each of the light emitting elements, further comprising a plurality of variable resistors connected in series in relation to the aforementioned light detecting element, and a plurality of differential amplifiers for comparing voltages generated in each of the variable resistors with a predetermined reference voltage and then adjusting the driving current of each light emitting element so that the difference between each of the aforementioned voltages and the reference voltage is no more than a certain constant. By finely adjusting the resistance value of each of the aforementioned variable resistors, the automatic power control circuit performs fine adjustments of the driving currents of each of the aforementioned light emitting elements, and maintains the emission intensity of each of the light emitting elements at a value corresponding to either the resistance value of, or the position of the movable contact of, the aforementioned finely adjusted variable resistors. Accordingly, if the resistance value of each of the variable resistors is finely adjusted, the automatic power control circuit of the present invention can adjust the emission intensity of those light emitting elements which are emitting light, both separately and accurately. In other words, it is possible to provide an automatic power control circuit which is so formed that even if the number of light detecting elements is fewer than the number of light emitting elements, the emission intensity of each of the light emitting elements can still be adjusted separately and accurately.

While there has been described what are at present considered to be preferred embodiments of the present invention, it will be understood that various modifications may be made thereto, and it is intended that the appended claims cover all such modifications as fall within the true spirit and scope of the invention.

What is claimed is:

1. An automatic power control circuit for automatically controlling emission intensity of each of a plurality of light emitting elements of a light source, said circuit comprising said plurality of light emitting elements and a light detecting element for detecting a portion of a light emitted from each of said light emitting elements, said circuit further comprising:
a plurality of variable resistors connected in series in relation to said light detecting element, and
a plurality of differential amplifiers for comparing each voltage generated at each of said variable resistors with a predetermined reference voltage and then adjusting a driving current of each of said light emitting elements so that a difference between each of said voltages and said reference voltage is no more than a certain constant,
wherein a resistance value of each of said variable resistors is finely adjusted to finely adjust said driving current of each of said light emitting elements, so as to maintain said emission intensity of each of said light emitting elements at a value corresponding to either said resistance value, or a position of a movable contact, of each finely adjusted variable resistor.

2. The automatic power control circuit according to claim 1, wherein said variable resistors are connected in parallel with one another.

3. The automatic power control circuit according to claim 1, wherein said variable resistors are connected in series with said light detecting element which is disposed between the variable resistors.

4. The automatic power control circuit according to claim 2, wherein said light detecting element is a reverse biased photodiode, and said variable resistors are connected to either one of a cathode and an anode of said photodiode.

5. The automatic power control circuit according to claim 3, wherein said light detecting element is a reverse biased photodiode, and said variable resistors are connected in series to a cathode and an anode respectively of said photodiode.
